(19) United States
(12) Patent Application Publication
(10) Pub. No.: US 2002/0003319 A1
(43) Pub. Date: Jan. 10, 2002

(54) Die and process especially for stamping detergent bars

(75) Inventors: Edward Ross Story, Baltimore, MD (US); Dean Lawrence Ashbaugh, Phoenix, MD (US); Arnold Brown, Owings Mills, MD (US); Pasquale Michael Buzzeo, Westminster, MD (US); Daniel John Heinz, Joppa, MD (US); Edward John Giblin, Finksburg, MD (US)

Correspondence Address: UNILEVER, PATENT DEPARTMENT, 45 RIVER ROAD, EDGEWATER, NJ, 07020, US

(73) Assignee: Lever Brothers Company, Division of Conopco, Inc.

(21) Appl. No.: 09/904,279

(22) Filed: Jul. 12, 2001

Related U.S. Application Data
(62) Division of application No. 08/774,472, filed on Dec. 30, 1996.

(51) Int. Cl. B29C 33/46; B29C 43/50

(52) U.S. Cl. 264/335; 425/422; 425/436 R

(57) ABSTRACT

A device for stamping a detergent bar, i.e. a bar comprising soap, a synthetic detergent active or a mixture thereof, includes a die half and a release fluid reservoir. The die is porous so that at least one bar stamping surface has pores through which a release fluid may be to facilitate clean release of the detergent bar cleanly after stamping. Good release of the detergent bars from the die is expected without or with reduced chilling of the dies.

### FIELD OF THE INVENTION

The present invention relates to a device and process for stamping a plastic material using a die to form a shaped article. In particular, it relates to process for stamping detergent bars and foods such as frozen dessert bars.

By “detergent bar” is meant a tablet, cake or bar in which the level of surface active agent, which comprises soap, synthetic detergent active or a mixture thereof, is at least 20 wt. % based on the bar.

### BACKGROUND OF THE INVENTION

In the manufacture of detergent bars, a preformed composition comprising all components of the bar is typically extruded from a nozzle to form a continuous “rod” which is cut into smaller pieces of predetermined length, commonly referred to as “billets.” These “billets” are then fed to a stamper or, alternatively, are given an imprint on one or more surfaces using, for example, a die of the same dimensions as the bar surface. The bar surface is hit with force by, eg., a mallet or a die in the shape of a roller.

Stampers typically have a die formed in two halves each with a surface which contacts the billet during the stamping operation. These surfaces are adapted to close to a preset separation distance, thereby compressing the billet between the die halves to give the bar its final shape and appearance, and then separate. Excess composition is squeezed out from the die halves as they close. This is commonly referred to as “flash.” The flash is then separated from the soap bar by transferring the bar through holes in a “deflashing plate.”

Conventional die stamping machines include “pin die” shaped machines in which a pair of opposing die members or die halves meet during a compaction step and a “box die” machine in which a pair of opposing die members stamp a bar held within a through-opening in a box frame but do not meet during compaction, the peripheral face of the bar being restrained by the box frame.

The die halves are often each provided with a die or ejector insert. These are normally held closed within the die halve by springs but can be pushed open by compressed air or mechanical means to assist in the release of the bar from the die. During closing of the die halves a vacuum can be applied to remove air trapped in the die cavity between the detergent bar and die surface and, in the case of rotary dies, this vacuum assists in retaining the bars in place during rotation.

Stamping of detergent bars using a die is carried out to give the bars a reproducible shape, smooth surface and/or to imprint a design such as a logo, trade mark or the like onto at least part of a surface of the bar. However, a problem with the ejectors is that they tend to apply higher pressure to a small area of the bar, which can cause problems for soft soap formulations.

Moreover, as a result of die-blocking, i.e. amounts of residual detergent left on die halves which builds up during continued use of the dies, bars are often formed with visible imperfections on their surfaces or they may not release from the die surface. Numerous solutions to these problems have been proposed. One solution involves chilling the die halves during the stamping operation. Chilling uses valuable resources, particularly energy sources.

Another solution is described in GB-A-746 769 which discloses a die set which includes a die box and a pair of companion die members made of plastic materials comprising polymers with a specified modulus of elasticity. A disadvantage with this system is that die release agent is necessary to prevent detergent from adhering to and building up on the dies and marring the surfaces of subsequently pressed bars.

Another solution is proposed in EP 276 971 which involves the use of two die members, each comprising a non-elastomeric and an elastomeric part. The elastomeric part, which contacts the soap bar during the stamping process, comprises an elastomer coating of at least 200 microns and having a modulus of elasticity within a specified range.

A disadvantage of thick coatings, such as those above 200 microns, is that typically they need to be applied via a casting or molding process performed on the die. As an alternative, separate parts are molded which are then attached to the die. The molding process involves manufacturing dies in which the cavities cut into the die are deeper than the final intended depth of the bar. Furthermore, a separate coating jig often needs to be employed to coat the ejectors.

During curing of the coating, shrinkage often occurs and although the volume may be insignificant, the shape change may result in gaps between the die and the ejector insert. Another difficulty which has been encountered with elastomeric coatings is that they tend to have short useful lives, on the order of a few days or more.

Roussel, U.S. Pat. No. 4,809,945 discloses a mold cavity for use in molding articles such as soap bars.

A porous die called Metapor has been used for vacuum molding applications in which a vacuum is pulled through the pores to form a shape over the die.

Fluid release agents are commonly applied in soap stamping to aid bar release. These fluids are sprayed or applied to the dies or billets prior to stamping. Unfortunately, this often results in excess release agent transferring to the stamping apparatus, to the transfer belts or to other machinery. Such transfer can cause operational difficulties such as coveyor belt slippage and the release fluid can be corrosive to the stamping machine metallic part (eg. brine). Undesirable products of corrosion can also be transferred to the product. Moreover, release agent can be wasted.

### SUMMARY OF THE INVENTION

The invention is directed to the discovery that of a new way to provide release agents to dies. In accordance with the invention, porous or otherwise permeable dies are utilized and the release agents are bled through the pores in the die so that they can be accurately applied to the die/product interface only.

In the case of stamping of soap bars, the invention permits application of the release agent to the bar rather than to the billet, with attendant accuracy in application. Excess fluid is eliminated and the die is repleneshed, eg by capillary action or from a fluid reservoir head.

In accordance with the present invention, release agent is applied evenly across the bar or other product being stamped due to the fact that it is distributed through the micropores of the die.

The invention encompasses the die/fluid feeding apparatus, as well as the process for stamping articles.

For a more complete understanding of the above and other features and advantages of the invention, reference should be made to the following detailed description of preferred embodiments and the accompanying drawings.

### BRIEF DESCRIPTION OF THE DRAWINGS

FIG. 1 is a cross section of a of one half of a soap stamping die taken along its transverse axis, in accordance with the invention .

### DETAILED DESCRIPTION OF THE INVENTION

Hereinafter by “surface decoration” is meant a uniform shape, smooth surface, a design such as a logo, trademark or the like.

The die of the invention is a porous die. The pores are within the range of from 2 to 500 microns in diameter, preferably from 5 to 50 microns, especially from 10 to 20 microns. By porous material herein is meant a material having pores within the range of from 2 to 500 microns in diameter. Preferably, the pores extend throughout the total soap-die contact area. Preferably the pores will constitute at least 15% of the available surface area of the total soap die contact area.

A preferred porous material of which the die can be constructed is Metapor F100 AL, a microporous, air permeable, aluminum available from Portec, North America, a division of NEST Technologies or from Portec, Ltd. a Swiss company. Another porous die material may be Porcerax II, a porous steel available from Mold Steel, Inc., of Erlanger, Ky., USA.

Preferably the die comprises a material selected from metals and their alloys, for example aluminum, brass and other copper alloys, steels including carbon and stainless steel and sintered forms of metals or metal composites, non-metallic materials such as ceramics, composites, thermosetting and thermoplastics in porous or foamed form.

It is expected that release agents already known for soap bar stamping may be employed in the present invention, subject to the need to apply the agent through the die pores. Examples of agents expected to be useful include brine, sodium isethionate solution, propylene glycol solution, isopropyl alcohol, moisturizing silicone oils and water. If desired, a release agent could be employed which also provides useful product characteristics to the soap, eg. a moisturizing agent.

The device according to the invention can be used to stamp a detergent bar comprising a surface active agent which comprises substantially soap or a synthetic detergent or a mixture of soap and synthetic detergent. It finds particular application in the stamping of soft and/or tacky detergent and/or mild bars which contain synthetic surfactants, translucent and transparent soap bars having a reduced fatty matter content, for example, in the range 63-78% wt. with respect to the total bar weight, and those bars containing skin beneficial agents such as humectants, polyols, oils, fatty acids and fatty alcohols.

According to a further aspect of the invention there is provided a process for stamping a detergent bar or other product comprising

i) feeding a detergent bar (or other) composition to a porous die;

ii) stamping the composition in the die to form a stamped product; and

iii) releasing the product from the die by introducing release agent to the bar surface through the pores of the die.

The invention may be used with conventional stamping equipment, such as Binacchi USN 100.

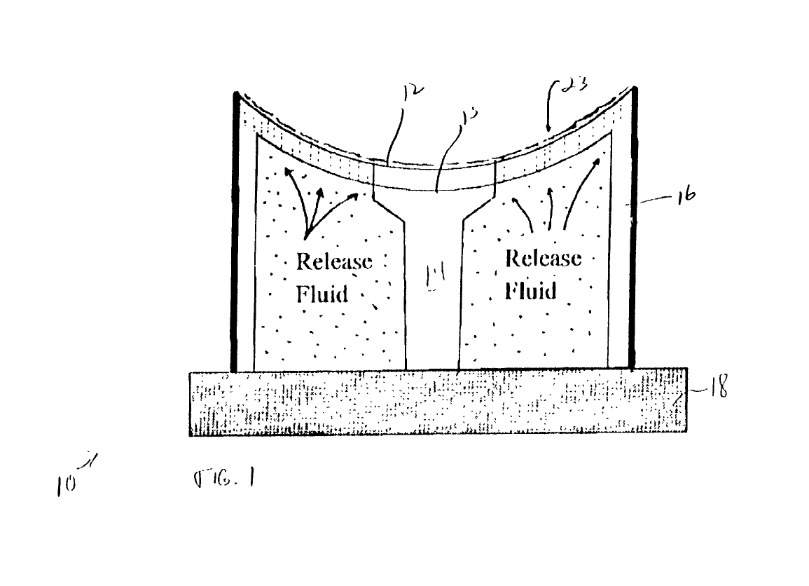

Referring to FIG. 1, die half 10 comprises bar stamping surface 12 and side walls 16. Die 10 is made of a porous material. Side walls 16 are sealed to prevent passage of release fluid therethrough, whereas bar stamping surface 12 and generally parallel inner die wall 13 are not sealed and permit release fluid to pass through. Optional ejector 14 may be provided centrally within the die. Ejectors are well known in the art. Side walls 16 rest on base 18.

A release fluid supply mechanism supplies fluid to the die. This can be, eg, via low pressure fluid supply system or reservoir head. The required pressure can be selected by one of ordinary skill depending on factors such as fluid viscosity, pore size, stamping rate, and the volume of fluid required for release of each bar. Since walls 16 are sealed and walls 12 and 13 are not, any fluid supplied passes through walls 12 and 13 and will contact any soap or other product resting on or in close proximity to die wall 12.

The operation will be described particularly with respect to soap bars. In operation, a soap billet is conveyed to a position intermediate two halves 10 of the die. The halves are conveyed to points proximate, or even in contact with, each other whereby surfaces 12 each contact the soap so that it assumes the desired shape and surface indicia. Release fluid 23 is present on the stamping surface 12 which it enters through the pores in the die. When it is desired to remove the soap from the die, due to the presence of the release fluid, the soap is cleanly removed from the die halves. The ejector, if used, assists in removing the soap from the die.

The release fluid may be fed through existing cooling channel systems in the case of rotating dies. For reciprocating dies, existing systems of external reservoir may be used.

It can be expected that use of the porous die will result in distribution of the soap bar release fluid across the whole surface of the bar. This may eliminate the need for the ejector mechanism and the force concentration which usually attends its use. Thus, a very soft soap and high liquid fraction formulations can be released without deformation. It is preferred that the micropores are distributed evenly through a large percentage of the bar contacting surfaces of the die. Preferably the pores constitute at least 15% of the surface area of the bar contacting surface of the die half.

Good release of the detergent bars from the die is expected without the expensive chilling of dies, which may otherwise need to be employed. Alternatively, reduced chilling of dies may be used.

“Die half” is understood to comprise one stamping surface of a die, even if a second, similar surface is not utilized.

The sealant used may be an adhesive resin or sealant such as an epoxy or acrylic resin. For example Loctite ShadowCurve® type AR—an aerosol applied clear acrylic. The coating is spray applied and dries in air. The resin could be liquid applied via brush or even dipped.

### EXAMPLE (PROPHETIC)

A range of die halves are manufactured from Metapor F100 AL, a microporous, air permeable, aluminum. The die halves are supplied with release fluid comprising brine.

The die halves are used to stamp the following soap formulations.

The bar compositions used in the examples are as follows:

| | % wt. |
|---|---|
| Formulation A | |
| Anhydrous tallow soap | 52.3 |
| Anhydrous coconut soap | 29.9 |
| Coconut fatty acid | 5.2 |
| Water and minors | to 100 |
| Formulation B | |
| Sodium cocyl isethionate | 27.00 |
| Cocoamidopropyl betaine | 5.00 |
| Polyethylene glycol, M.Wt. | 33.12 |
| Fatty acid | 11.00 |
| Sodium stearate | 5.00 |
| Water + minors | to 100 |
| Formulation C | |
| Sodium cocyl isethionate | 49.78 |
| 82/18 Soap | 8.31 |
| Sodium Stearate | 2.98 |
| Alkyl Benzene sulphonate | 2.02 |
| Stearic acid | 20.15 |
| Coco fatty acid | 3.08 |
| Sodium Isethionate | 4.68 |
| Water + minors | to 100 |

After stamping, the soap releases cleanly from the die halves without the use of an ejector.

It should be understood, of course, that the specific forms of the invention herein illustrated and described are intended to be representative only as certain changes may be made therein without departing from the clear teachings of the disclosure. Accordingly, reference should be made to the following appended claims in determining the full scope of the invention.

What is claimed is:

1. A device for stamping a detergent bar comprising a die half made of a porous material having at least one substrate stamping surface, and a supply of release fluid situated to impose fluid through the porous material to the substrate stamping surface.

2. The device according to claim 1 wherein the release fluid is selected from the group consisting of brine, sodium isethionate solution, propylene glycol solution, isopropyl alcohol, silicone oil and water.

3. The device according to claim 1 wherein the die is made of a metal.

4. The device according to claim 1 wherein the die comprises a material selected from metals and their alloys sintered metals and metallic composites; non-metallic materials such as ceramics, thermoplastics and thermosetting resins.

5. The device according to claim 1 wherein the release fluid is brine.

6. A process for stamping a soap bar comprising
i) feeding a detergent bar composition to one or more porous die halves having a bar stamping surface:
ii) stamping the composition in the die using the die halves to form a stamped bar; and
iii) facilitating the release of the bar form the die by, at some time during the process, feeding a release through pores of the die to the bar stamping surface.

7. The process according to claim 8 wherein the release fluid is selected from the group consisting of brine, AIT and alcohol.

8. The process according to claim 6 wherein a surface decoration which comprises a logo or a trademark is imposed by the die half.

9. The die according to claim 3 wherein the die is aluminum.

10. The die according to claim 3 wherein the die is stainless steel.

11. A process for molding a detergent product comprising
i) feeding a detergent composition to a porous mold having a detergent contacting surface; and
ii) releasing at some time during the process, the composition from the mold by feeding a pressurized fluid through pores of the mold to the detergent contacting surface.

12. The process according to claim 11 wherein the fluid is brine.

13. The process according to claim 11 wherein the product is a soap bar.

14. The device according to claim 1 wherein said apparatus further includes a reservoir head containing the supply of release fluid.

15. A device for stamping a detergent bar comprising a die half made of a porous material having at least one detergent bar stamping surface, and a container for release fluid situated to impose fluid through the porous material to the detergent bar stamping surface.
